(19) United States
(12) Patent Application Publication
(10) Pub. No.: US 2025/0110873 A1
(43) Pub. Date: Apr. 3, 2025

(54) SYSTEMS, METHODS, AND APPARATUS FOR CACHE MANAGEMENT IN A MEMORY DEVICE

(71) Applicant: Samsung Electronics Co., Ltd., Suwon-si (KR)

(72) Inventors: Jongmin GIM, Pleasanton, CA (US); Heekwon PARK, San Jose, CA (US); Jaemin JUNG, San Jose, CA (US); Changho CHOI, San Jose, CA (US); Yang Seok KI, Palo Alto, CA (US)

(21) Appl. No.: 18/749,563

(22) Filed: Jun. 20, 2024

Related U.S. Application Data
(60) Provisional application No. 63/541,774, filed on Sep. 29, 2023.

(51) Int. Cl. G06F 12/0802

(52) U.S. Cl. CPC G06F 12/0802; G06F 2212/60

(57) ABSTRACT

A system may include a memory device including memory media and storage media, wherein the memory device is configured to perform one or more operations including sending access information; receiving address information; and populating, from the storage media, the memory media with data using the address information; and a device including one or more circuits, wherein the one or more circuits is configured to perform one or more operations including receiving, from the memory device, the access information; determining, using the access information and application weights, the address information; and sending, to the memory device, the address information. The one or more circuits may be further configured to perform one or more operations including sending, to a training system, trace information; receiving a weight set from the training system, wherein the weight set is based on the trace information; and modifying the application weights based on the weight set.

### REFERENCE TO RELATED APPLICATION

This application claims priority to, and the benefit of, U.S. Provisional Patent Application Ser. No. 63/541,774, filed on Sep. 29, 2023, which is incorporated by reference.

### TECHNICAL FIELD

This disclosure relates generally to memory devices, and more specifically to systems, methods, and apparatus for cache management in a memory device.

### BACKGROUND

A memory device may include memory media and storage media. In response to receiving a load request (e.g., a memory access request), the memory device may check the memory media for data corresponding to the load request. In response to a cache hit (e.g., the data is found on the memory media), the data may be returned from the memory media. In response to a cache miss (e.g., the data is not found on the memory media), the memory device may retrieve a region of memory, which includes the requested data, from the storage media.

The above information disclosed in this Background section is only for enhancement of understanding of the background of the invention and therefore it may contain information that does not constitute prior art.

### SUMMARY

In some aspects, the techniques described herein relate to a method including receiving, from a memory device, access information for an application; and determining, using the access information and application weights, address information. In some aspects, the application weights correspond to a usage of the application. In some aspects, the access information includes at least one of one or more addresses and timestamp information. In some aspects, the method further includes sending, to the memory device, the address information. In some aspects, the method further includes filtering entries of store requests from the access information. In some aspects, sending the address information includes determining an available size of a memory media; and returning the address information based on the available size of the memory media. In some aspects, the method further includes sending trace information to a training system, wherein the trace information corresponds to an operation of an application; receiving a weight set from the training system, wherein the weight set is based on the trace information; and modifying the application weights based on the weight set. In some aspects, the access information is first access information; and wherein the trace information includes second access information. In some aspects, the trace information includes load information for an application.

In some aspects, the techniques described herein relate to a device including memory media; storage media; and one or more circuits configured to perform one or more operations including sending access information; receiving address information based on the access information; and populating, from the storage media using the address information, the memory media with data. In some aspects, the access information includes access data for an application on the memory media and storage media. In some aspects, the address information corresponds to an application on a host device.

In some aspects, the techniques described herein relate to a system including a memory device including memory media and storage media, wherein the memory device is configured to perform one or more operations including sending access information; receiving address information; and populating, from the storage media, the memory media with data using the address information; and a device including one or more circuits, wherein the one or more circuits is configured to perform one or more operations including: receiving, from the memory device, the access information; determining, using the access information and application weights, the address information; and sending, to the memory device, the address information. In some aspects, the application weights correspond to a usage of an application. In some aspects, the access information includes at least one of one or more addresses and timestamp information. In some aspects, the one or more circuits is further configured to perform one or more operations including modifying the access information. In some aspects, modifying the access information includes filtering entries of store requests from the access information. In some aspects, sending the address information includes determining an available size of the memory media; and returning the address information based on the available size of the memory media. In some aspects, the one or more circuits is further configured to perform one or more operations including sending, to a training system, trace information; receiving a weight set from the training system, wherein the weight set is based on the trace information; and modifying the application weights based on the weight set. In some aspects, the access information is first access information; and wherein the trace information includes second access information.

### BRIEF DESCRIPTION OF THE DRAWINGS

The figures are not necessarily drawn to scale and elements of similar structures or functions may generally be represented by like reference numerals or portions thereof for illustrative purposes throughout the figures. The figures are only intended to facilitate the description of the various embodiments described herein. The figures do not describe every aspect of the teachings disclosed herein and do not limit the scope of the claims. To prevent the drawings from becoming obscured, not all of the components, connections, and the like may be shown, and not all of the components may have reference numbers. However, patterns of component configurations may be readily apparent from the drawings. The accompanying drawings, together with the specification, illustrate example embodiments of the present disclosure, and, together with the description, serve to explain the principles of the present disclosure.

FIG. 1 illustrates an embodiment of a memory device scheme in accordance with example embodiments of the disclosure.

FIG. 2A illustrates another embodiment of a memory device scheme in accordance with example embodiments of the disclosure.

FIG. 2B illustrates another embodiment of a memory device scheme in accordance with example embodiments of the disclosure.

FIG. 3 illustrates an example of a cache management process in accordance with example embodiments of the disclosure.

FIG. 4 illustrates an example of preparing a training input workload in a target system in accordance with example embodiments of the disclosure.

FIG. 5 illustrates an example of training in a training server in accordance with example embodiments of the disclosure.

FIG. 6 illustrates a flowchart of a method for managing a cache in a memory device in accordance with example embodiments of the disclosure.

FIG. 7 illustrates an example of managing the cache in a memory device in accordance with example embodiments of the disclosure.

FIG. 8 illustrates a flowchart of an example procedure to populate the cache using a training server in accordance with example embodiments of the disclosure.

### DETAILED DESCRIPTION

In some embodiments, in response to receiving a load request, a memory device may check memory media for data corresponding to the load request. In some embodiments, in response to a cache hit (e.g., the data is found on the memory media), the data may be returned from the memory media. In response to a cache miss (e.g., the data is not found on the memory media), the memory device may retrieve a region of memory, which includes the requested data, from storage media, copy the region of memory to the memory media, and return the data from the memory media.

Generally, retrieving data from memory media may be performed faster than retrieving the data from storage media. To improve the performance of the memory device, in some embodiments, data may be copied to the memory media in anticipation of future requests to increase the cache hit rate. However, based on the cache management policy of the memory device, loading data to the memory media may not be optimized for specific applications. Thus, in some embodiments, by modifying a cache management policy using artificial intelligence (AI), the memory media may be populated in such a way that allows for more cache hits relative to other cache management policies.

For example, according to embodiments of the disclosure, a training server may receive runtime trace data (e.g., addresses, timestamps, and/or metadata from the memory device for an application workload) for an application from a host (e.g., target system). In some embodiments, the training server may calculate weights for the application for the target system using the runtime trace data. In some embodiments, the target system may receive the calculated weights and infer memory addresses to load to the memory media from the storage media based on the weights and log data (e.g., addresses, timestamps, and/or metadata from the memory device for an application) from the memory device.

This disclosure encompasses numerous aspects relating to devices with memory and storage configurations. The aspects disclosed herein may have independent utility and may be embodied individually, and not every embodiment may utilize every aspect. Moreover, the aspects may also be embodied in various combinations, some of which may amplify some benefits of the individual aspects in a synergistic manner.

For purposes of illustration, some embodiments may be described in the context of some specific implementation details such as devices implemented as memory devices that may use specific interfaces, protocols, and/or the like. However, the aspects of the disclosure are not limited to these or any other implementation details.

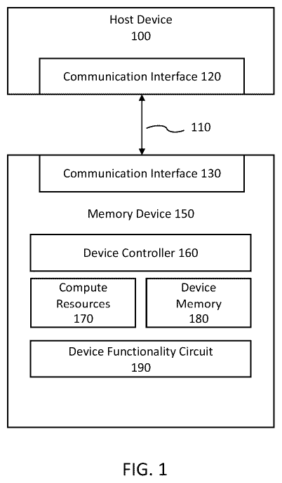

FIG. 1 illustrates an embodiment of a memory device scheme in accordance with example embodiments of the disclosure. The embodiment illustrated in FIG. 1 may include one or more host devices 100 and one or more memory devices 150 configured to communicate using one or more communication connections 110.

In some embodiments, a host device 100 may be implemented with any component or combination of components that may utilize one or more features of a memory device 150. For example, a host may be implemented with one or more of a server, a storage node, a compute node, a central processing unit (CPU), a workstation, a personal computer, a tablet computer, a smartphone, and/or the like, or multiples and/or combinations thereof.

In some embodiments, a memory device 150 may include a communication interface 130, memory 180 (some or all of which may be referred to as device memory), one or more compute resources 170 (which may also be referred to as computational resources), a device controller 160, and/or a device functionality circuit 190. In some embodiments, the device controller 160 may control the overall operation of the memory device 150 including any of the operations, features, and/or the like, described herein. For example, in some embodiments, the device controller 160 may parse, process, invoke, and/or the like, commands received from the host devices 100.

In some embodiments, the device functionality circuit 190 may include any hardware to implement the primary function of the memory device 150. For example, the device functionality circuit 190 may include storage media such as magnetic media (e.g., if the memory device 150 is implemented as a hard disk drive (HDD) or a tape drive), solid-state media (e.g., one or more flash memory devices), optical media, and/or the like. For instance, in some embodiments, a memory device may be implemented at least partially as a solid-state drive (SSD) based on NAND flash memory, persistent memory (PMEM) such as cross-gridded nonvolatile memory, memory with bulk resistance change, phase change memory (PCM), or any combination thereof. In some embodiments, the device controller 160 may include a media translation layer such as a flash translation layer (FTL) for interfacing with one or more flash memory devices. In some embodiments, the memory device 150 may be implemented as a computational storage drive, a computational storage processor (CSP), and/or a computational storage array (CSA).

As another example, if the memory device 150 is implemented as an accelerator, the device functionality circuit 190 may include one or more accelerator circuits, memory circuits, and/or the like.

In some embodiments, the compute resources 170 may be implemented with any component or combination of components that may perform operations on data that may be received, stored, and/or generated at the memory device 150. Examples of compute engines may include combinational logic, sequential logic, timers, counters, registers, state machines, complex programmable logic devices (CPLDs), field programmable gate arrays (FPGAs), application-specific integrated circuits (ASICs), embedded processors, microcontrollers, central processing units (CPUs) such as complex instruction set computer (CISC) processors (e.g., x86 processors) and/or a reduced instruction set computer (RISC) processors such as ARM processors, graphics processing units (GPUs), data processing units (DPUs), neural processing units (NPUs), tensor processing units (TPUs), and/or the like, that may execute instructions stored in any type of memory and/or implement any type of execution environment such as a container, a virtual machine, an operating system such as Linux, an Extended Berkeley Packet Filter (eBPF) environment, and/or the like, or a combination thereof.

In some embodiments, the memory 180 may be used, for example, by one or more of the compute resources 170 to store input data, output data (e.g., computation results), intermediate data, transitional data, and/or the like. The memory 180 may be implemented, for example, with volatile memory such as dynamic random-access memory (DRAM), static random-access memory (SRAM), and/or the like, as well as any other type of memory such as non-volatile memory.

In some embodiments, the memory 180 and/or compute resources 170 may include software, instructions, programs, code, and/or the like, that may be performed, executed, and/or the like, using one or more compute resources (e.g., hardware (HW) resources). Examples may include software implemented in any language such as assembly language, C, C++, and/or the like, binary code, FPGA code, one or more operating systems, kernels, environments such as eBPF, and/or the like. Software, instructions, programs, code, and/or the like, may be stored, for example, in a repository in memory 180 and/or compute resources 170. In some embodiments, software, instructions, programs, code, and/or the like, may be downloaded, uploaded, sideloaded, pre-installed, built-in, and/or the like, to the memory 180 and/or compute resources 170. In some embodiments, the memory device 150 may receive one or more instructions, commands, and/or the like, to select, enable, activate, execute, and/or the like, software, instructions, programs, code, and/or the like. Examples of computational operations, functions, and/or the like, that may be implemented by the memory 180, compute resources 170, software, instructions, programs, code, and/or the like, may include any type of algorithm, data movement, data management, data selection, filtering, encryption and/or decryption, compression and/or decompression, checksum calculation, hash value calculation, cyclic redundancy check (CRC), weight calculations, activation function calculations, training, inference, classification, regression, and/or the like, for AI, machine learning (ML), neural networks, and/or the like.

In some embodiments, a communication interface 120 at a host device 100, a communication interface 130 at a memory device 150, and/or a communication connection 110 may implement, and/or be implemented with, one or more interconnects, one or more networks, a network of networks (e.g., the internet), and/or the like, or a combination thereof, using any type of interface, protocol, and/or the like. For example, the communication connection 110, and/or one or more of the interfaces 120 and/or 130 may implement, and/or be implemented with, any type of wired and/or wireless communication medium, interface, network, interconnect, protocol, and/or the like including Peripheral Component Interconnect Express (PCIe), NVMe, NVMe over Fabric (NVMe-oF), Compute Express Link (CXL), and/or a coherent protocol such as CXL.mem, CXL.cache, CXL.io and/or the like, Gen-Z, Open Coherent Accelerator Processor Interface (OpenCAPI), Cache Coherent Interconnect for Accelerators (CCIX), and/or the like, Advanced extensible Interface (AXI), Direct Memory Access (DMA), Remote DMA (RDMA), RDMA over Converged Ethernet (ROCE), Advanced Message Queuing Protocol (AMQP), Ethernet, Transmission Control Protocol/Internet Protocol (TCP/IP), FibreChannel, InfiniBand, Serial ATA (SATA), Small Computer Systems Interface (SCSI), Serial Attached SCSI (SAS), iWARP, any generation of wireless network including 2G, 3G, 4G, 5G, 6G, and/or the like, any generation of Wi-Fi, Bluetooth, near-field communication (NFC), and/or the like, or any combination thereof. In some embodiments, a communication connection 110 may include one or more switches, hubs, nodes, routers, and/or the like.

In some embodiments, a memory device 150 may be implemented in any physical form factor. Examples of form factors may include a 3.5 inch, 2.5 inch, 1.8 inch, and/or the like, storage device (e.g., storage drive) form factor, M.2 device form factor, Enterprise and Data Center Standard Form Factor (EDSFF) (which may include, for example, E1.S, E1.L, E3.S, E3.L, E3.S 2T, E3.L 2T, and/or the like), add-in card (AIC) (e.g., a PCIe card (e.g., PCIe expansion card) form factor including half-height (HH), half-length (HL), half-height, half-length (HHHL), and/or the like), Next-generation Small Form Factor (NGSFF), NF1 form factor, compact flash (CF) form factor, secure digital (SD) card form factor, Personal Computer Memory Card International Association (PCMCIA) device form factor, and/or the like, or a combination thereof. Any of the computational devices disclosed herein may be connected to a system using one or more connectors such as SATA connectors, SCSI connectors, SAS connectors, M.2 connectors, EDSFF connectors (e.g., 1C, 2C, 4C, 4C+, and/or the like), U.2 connectors (which may also be referred to as SSD form factor (SSF) SFF-8639 connectors), U.3 connectors, PCIe connectors (e.g., card edge connectors), and/or the like.

Any of the memory devices disclosed herein may be used in connection with one or more personal computers, smart phones, tablet computers, servers, server chassis, server racks, datarooms, datacenters, edge datacenters, mobile edge datacenters, and/or any combinations thereof.

In some embodiments, a memory device 150 may be implemented with any device that may include, or have access to, memory, storage media, and/or the like, to store data that may be processed by one or more compute resources 170. Examples may include memory expansion and/or buffer devices such as CXL type 2 and/or CXL type 3 devices, as well as CXL type 1 devices that may include memory, storage media, and/or the like.

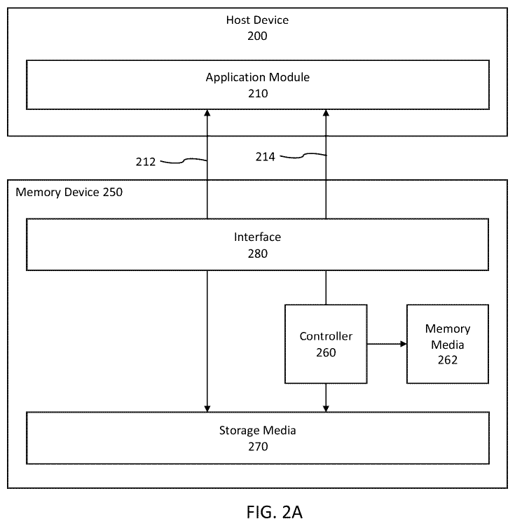

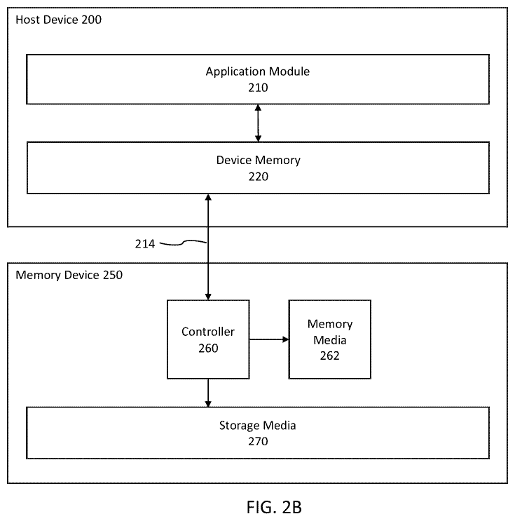

FIG. 2A illustrates another embodiment of a memory device scheme in accordance with example embodiments of the disclosure. In some embodiments, the memory device may be a dual-mode memory device (e.g., the memory device that may support I/O block accesses and memory accesses). The embodiment illustrated in FIG. 2A may include one or more host devices 200 and one or more memory devices 250. In some embodiments, the host device 200 and memory device 250 may be similar to the host device 100 and memory device 250 illustrated in FIG. 1. In some embodiments, the host device 200 may include an application module 210, and the memory device 250 may include a controller 260, memory media 262, storage media 270, and an interface 280. In some embodiments, the interface 280 and controller 260 may be implemented on one or more circuits of the memory device 250. In some embodiments, the memory media 262 may be relatively fast memory such as DRAM and the storage media 270 may be slower non-volatile memory, such as not-AND (NAND) flash memory. In some embodiments, the application module 210 may run an application that may access data from the memory device 250 in two ways. In some embodiments, the application module 210 may request data from the memory device 250 by using an I/O block access request 212. In particular, by using an I/O block access request 212, the application module 210 may receive data from the storage media 270 using a memory access protocol (e.g., CXL.io) through an I/O bridge to a DMA engine on the memory device 250. In some embodiments, the application module 210 may also request data by using another memory access protocol (e.g., CXL.mem) to the controller 260 to access the memory media 262. In some embodiments, an I/O block access request may allow the host device 200 to access the storage media 270 using general read and write commands, and a memory access request may allow the host to access the memory media 262 using load and store commands.

FIG. 2B illustrates another embodiment of a memory device scheme in accordance with example embodiments of the disclosure. The elements illustrated in FIG. 2B may be similar elements to those illustrated in FIG. 2A in which similar elements may be indicated by reference numbers ending in, and/or containing, the same digits, letters, and/or the like. The host device 200 in FIG. 2B may further include device memory 220. In some embodiments, the device memory 220 may be host-managed device memory (HDM). In some embodiments, the address of data on the memory media 262 may be mapped to an HDM address on the device memory 220. In some embodiments, a memory access protocol (e.g., CXL.mem) may be used to access the HDM memory range (and to the memory media 262 mapped to the HDM memory range) if the host device 200 may not access addresses on the storage media 270 directly (e.g., using a memory access request as opposed to using I/O block access requests).

In some embodiments, the host device 200 may send a request (e.g., memory access request 214) to the memory device 250 to retrieve data from the memory media 262. In some embodiments, the request (e.g., memory access request 214) may use a memory access protocol (e.g., CXL.mem) to access the memory media 262. In some embodiments, in response to receiving a memory access request 214 (e.g., load request), the memory device 250 may request that the controller 260 check the memory media 262 for the requested data corresponding to the load request. In some embodiments, in response to a cache hit (e.g., the data is found on the memory media 262), the data may be returned directly from the memory media 262. In some embodiments, in response to a cache miss (e.g., the data is not found on the memory media 262), the controller 260 may copy the data from the storage media 270 to the memory media 262 and return the data from the memory media 262. In this way, in some embodiments, the controller 260 may play a role in managing the replacement of data on the memory media 262 and facilitating memory accesses from the host device 200. For illustrative purposes, the size of the device memory 220 and storage media 270 may be 512 GB, and the size of the memory media 262 may be 16 GB. In some embodiments, the size of the memory media 262 (e.g., 16 GB) may be small relative to the size of the storage media 270 (e.g., 512 GB), and the controller 260 may replace data on the memory media 262 with data stored on the storage media 270. In some embodiments, as data is replaced from the memory media 262, existing data on the memory media 262 may be erased to make room for the new data. Thus, data may be copied from the storage media 270 to the memory media 262 as needed. In some embodiments, using memory media 262 may improve the bandwidth and latency as compared to accessing the storage media 270, since the memory media may generally be faster memory. Thus, a cache replacement policy may be used to improve the performance of the memory device 250 as viewed by the host device 200.

In some embodiments, by using a memory cache management model (e.g., cache replacement policy) using AI, the memory media may be populated more efficiently allowing for less latency, since the memory media may be populated by inferred data. For example, an AI-powered cache management model may be implemented on the memory device for data on the memory media. In some embodiment, the AI-powered cache management model for a memory device may support three phases: preparing a training input workload in a target system, training in a training server, and inferencing in a target system. Each phase will be described in more detail below.

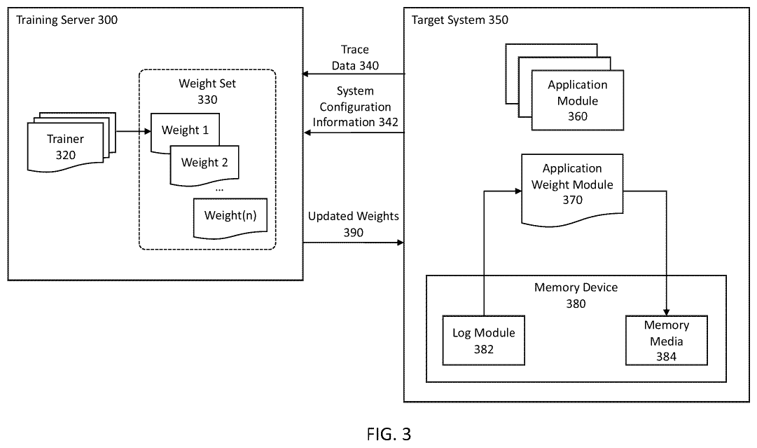

FIG. 3 illustrates an example of an operating environment in accordance with example embodiments of the disclosure. FIG. 3 illustrates a target system 350 and a training server 300. The target system 350 may include the host device 200 and memory device 250 of FIG. 2A. In some embodiments, the target system 350 may further include an application module 360, application weight module 370, and memory device 380. In some embodiments, the memory device 250 may include a log module 382 and memory media 384. In some embodiments, the training server 300 may include a trainer 320 and a weight set module 330.

In some embodiments, the target system 350 may collect trace data 340 using the application module 360. For example, the application module 360 may run a given workload, and the target system 350 may generate the trace data 340 based on the output of the application module 360. In some embodiments, the trace data 340 may include addresses accessed from the memory device 380, timestamps of the memory accesses, and/or metadata from the memory device 380. In some embodiments, the trace data 340 may encompass multiple workloads executed on the target system 350 by the application module 360. In some embodiments, the system configuration information 342 may include hardware and/or software configuration information for the target system 350. In some embodiments, the target system 350 may send the trace data 340 and system configuration information 342 to the training server 300. In some embodiments, the training server 300 may receive the trace data 340 and system configuration information 342 and input the trace data 340 and system configuration information 342 to the trainer 320. In some embodiments, the trainer 320 may calculate values for the weight set (e.g., weights for a given application and/or configuration) using the trace data 340 for a given system configuration (e.g., based on the system configuration information 342). For example, the trainer 320 may use an ML model to generate weights at the weight set module 330 that capture the overall predictable patterns of a given application using the trace data 340 captured from the target system 350. In some embodiments, the training server 300 may send updated weights 390 (weights calculated at the weight set module 330 for a given application and/or configuration) to the target system 350, and the target system 350 may update the weights on the application weight module 370 based on the updated weights 390. In some embodiments, the training server 300 may continue to receive runtime trace data from the target system 350 to update the weights on the weight set module 330, and the training server 300 may send the updated weights 390 to the target system 350.

In some embodiments, the system configuration information may include information such as non-uniform memory access (NUMA) configuration information, memory partition information, memory partition size information, memory tiering size information, buddy algorithm information, version information, and/or interleaving switching information, among others.

In some embodiments, the memory device 380 may send log information from the log module 382 (e.g., memory addresses and/or timestamps), which may be received by the application weight module 370. In some embodiments, the application weight module 370 may output inferred high-priority accesses (HPAs) with a certain percentage of probability for expected data to the memory device 380 based on the log information and weights, which may be used to populate the memory media 384. The above steps will be further described in more detail below.

In some embodiments, data other than trace data 340 may be sent to the training server 300. For example, system configuration or usage statistics may be sent to the training server 300. Any data that may be used to calculate weights is within the scope of the disclosure. In some embodiments, updated weights 390 may not be sent to the target system 350, and data used to calculate weights may be received at the application weight module 370, where the application weight module 370 may calculate weights for the application. Any of application module 360 and application weight module 370 may be implemented on one or more circuits of the target system 350.

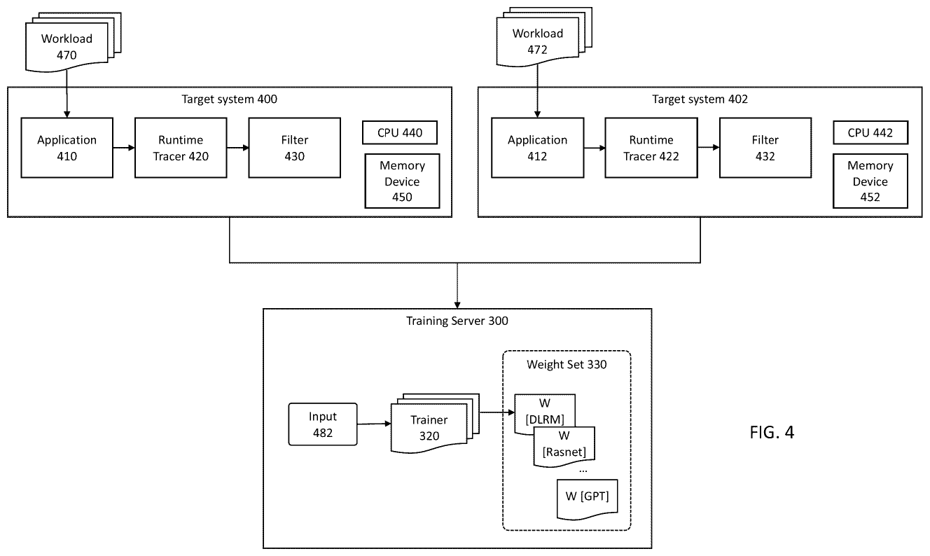

FIG. 4 illustrates an example of preparing a training input workload in a target system in accordance with example embodiments of the disclosure. The elements illustrated in FIG. 4 may be similar elements to those illustrated in FIG. 3 in which similar elements may be indicated by reference numbers ending in, and/or containing, the same digits, letters, and/or the like. In some embodiments, target systems 400 and 402 may include application modules 410 and 412, runtime tracers 420 and 422, filters 430 and 432, CPUs 440 and 442, and memory devices 450 and 452, respectively. In some embodiments, any of application modules 410 and 412, runtime tracers 420 and 422, and filters 430 and 432 may be implemented on one or more circuits of the target systems 400 and 402. In some embodiments, the target systems 400 and 402 may be servers that run specific applications or may be sample systems that represent a desired operating environment. In some embodiments, the target systems 400 and 402 may be the target system 350 in FIG. 3. In some embodiments, the workloads 470 and 472 may be executed by the application modules 410 and 412. In some embodiments, the runtime tracers 420 and 422 may generate trace data using the application modules 410 and 412. In some embodiments, the trace data may contain information such as load/store addresses, timestamps, and/or metadata. In some embodiments, applications on the application modules 410 and 412 may be run multiple times to generate the runtime trace data for the runtime tracers 420 and 422. In some embodiments, the filters 430 and 432 may filter data from the runtime tracers 420 and 422. For example, the filters 430 and 432 may filter data related to store requests (e.g., requests to store data on the memory devices 450 and 452) from the runtime tracers 420 and 422. In some embodiments, because the system may not infer data related to store requests, only data related to load requests may be sent to a training server 480. In other words, since store request data is related to data that was stored to the memory device and not data read from the memory device for a given workload, it may not be used to infer HPAs to be used to load data to the memory media. In some embodiments, the filters 430 and 432 may filter memory accesses that are performed on the host memory or device memory. In some embodiments, timestamps and other metadata may undergo a similar filtration process.

In some embodiments, a memory access pattern may demonstrate notable variations influenced by several factors, including system software configuration, application configuration, hardware configuration, and the size and proportion of system memory. In some embodiments, the runtime trace may be sensitive to the configuration of the hardware and software system. Therefore, in some embodiments, utilizing a trace specific to the target systems 400 and 402 as the input workload for inference weights related to the target systems 400 and 402 may be desired. In some embodiments, the target systems 400 and 402 may pass the filtered runtime data to the training server 300. In the example operating environment of FIG. 3, the target systems 400 and 402 are shown. However, additional target systems can also pass data to the training server 300, and target systems can be grouped by application, memory, and/or system configuration by the training server 300, as explained in further detail below.

In some embodiments, when an application is executed, the memory devices 450 and 452 may generate physical access patterns, which are stored as device physical addresses (DPA) patterns. In some embodiments, the DPA patterns may be stored in a log where a host device driver on the target systems 400 and 402 can collect the DPA patterns. In some embodiments, the target systems 400 and 402 may merge DPA patterns from multiple memory devices into a physical address data set and convert the DPA patterns to HPA patterns; e.g., the HPA patterns may allow the target systems 400 and 402 to know which DPA patterns are associated with which memory device. In some embodiments, the HPA patterns may be sent to the training server 480 as runtime data to train the weight.

In some embodiments, the runtime data may be generated using a sample target system. For example, the target system 402 may be a sample target system used to generate a weight set and may not be a target system in, e.g., a datacenter. In some embodiments, an application may execute multiple application workloads and output the runtime data using the multiple application workloads.

In some embodiments, the input data from the target systems 400 and 402 may be received at input module 482. In some embodiments, the input data may be output by the input module to the trainer 320. In some embodiments, the input data may be used by the trainer 320 to calculate the weights at the weight set module 330, which will be described in more detail below.

Although FIG. 4 illustrates operations on a training server, the operations may be performed on the target system. For example, the target system may calculate a weight set using application data and populate a cache using the weight set. Furthermore, the target system may receive data from other target systems, and use that data in calculating a weight set.

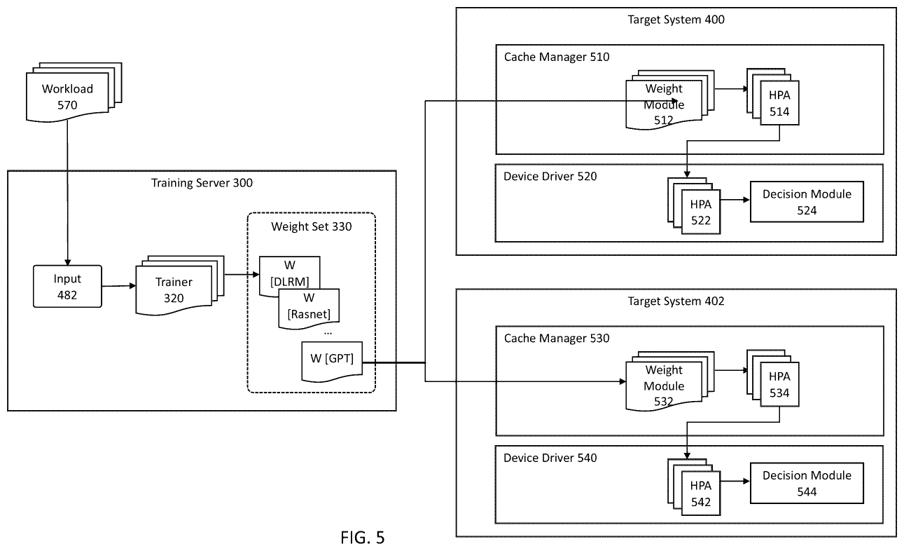

FIG. 5 illustrates an example of training in a training server in accordance with example embodiments of the disclosure. The elements illustrated in FIG. 5 may be similar elements to those illustrated in FIG. 4 in which similar elements may be indicated by reference numbers ending in, and/or containing, the same digits, letters, and/or the like. FIG. 5 may further include a workload 570. In some embodiments, the target systems 400 and 402 may further include cache managers 510 and 530, and device drivers 520 and 540. In some embodiments, the cache managers 510 and 530, and device drivers 520 and 540 may be implemented on one or more circuits on target systems 400 and 402. In some embodiments, the cache managers 510 and 530 may include weight modules 512 and 532, and HPA modules 514 and 534. In some embodiments, the weight modules 532 and 532 may receive application weights from the target system and calculate the inferred HPA patterns.

In some embodiments, the training server 300 may use the data received from one or more target systems and calculate weights for a particular application running on a specifically configured target system. For example, the training server 300 may receive an input based on a workload 570 running on the target system 400, target system 402, and/or any other target system. In some embodiments, the input from the input module 482 may be used by the trainer 320 to train weights for an application. In some embodiments, the weights can be calculated using an ML algorithm. In some embodiments, the weights may be set by a first iteration of the weights being calculated and may be updated as additional runtime data (e.g., input from the input module 482) is received. In some embodiments, the weights may also be calculated for other configurations, such as use case, other system configurations, and the like. Furthermore, in some embodiments, other algorithms may be used to calculate the weight set and an ML algorithm is just one example used to calculate the weights.

In some embodiments, the trainer 320 may receive an input at an input module 482 and calculate weights for a weight set module 330 for the given application and system configuration. In the example, weights may be configured for a specific application. However, in some embodiments, weights may not be for a specific application, and can be weights for different configurations, such as system type, use case, etc. In some embodiments, a training server may not be in a one-to-one relationship with a target system and may be a one-to many with multiple target systems. In some embodiments, as the number of target systems and the amount of the runtime data increase, the trainer 320 can be continuously trained to provide updated weights for a given application and configuration. In some embodiments, the input module 482, trainer 320, and weight set module 330 may be implemented on one or more circuits on the training server 300.

In some embodiments, the training may be performed on a server provided by a service provider. For example, a service provider may be specially configured to calculate weights for an application. In some embodiments, training in the training server 300 may generate distinct weights for an application, workload, and system hardware configuration. In some embodiments, the training server 300 may virtually mimic a target system using the system configuration information and use logging information to generate the weights. In some embodiments, the training server 300 may be a specialized system that allows it to calculate weights for a given application and configuration more quickly than on the target system.

In some embodiments, the training model may be able to accommodate training input workloads from training target systems (e.g., target systems used for training). In some embodiments, the training server may maintain multiple sets of weights for each application's inference on each target system to ensure compatibility and optimization for each specific system. In some embodiments, the training server may support online updates, allowing the replacement of weights in the target system during runtime. This may allow for real-time adjustments and enhancements to the system's performance.

In some embodiments, weights may be generated for an application and system configuration. For example, if two systems run the same application but have different system configurations, the training server 300 may generate separate weight sets (e.g., weights) to be used by the two systems. In addition, training for the weight sets may only use data for a specific configuration to generate the weight set for that configuration.

In some embodiments, the target systems 400 and 402 may receive weights from the weight set module 330. In some embodiments, the received weights may be used to update the weights on the weight modules 512 and 532. In some embodiments, the weight modules 512 and 532 may generate the HPA patterns for the HPA modules 514 and 534. In some embodiments, the HPA patterns may be sent to the device drivers 520 and 540 (e.g., received at HPA modules 522 and 542). In some embodiments, the device drivers 520 and 540 may use the decision modules 524 and 544 to send inferred HPA patterns to memory devices as will be described in further detail below.

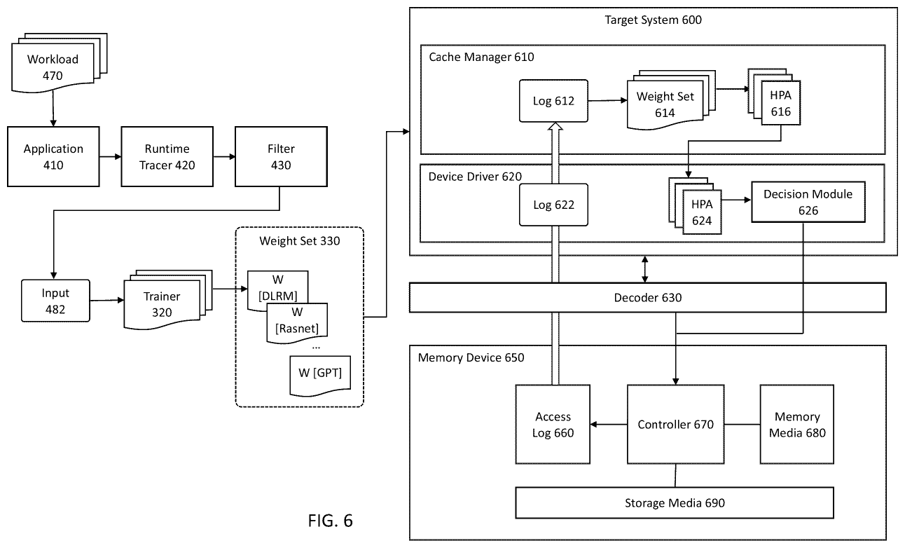

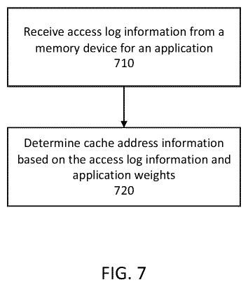

FIG. 6 illustrates a method for managing a cache in a memory device in accordance with example embodiments of the disclosure, and FIG. 7 illustrates an example of managing the cache in a memory device in accordance with example embodiments of the disclosure. The elements illustrated in FIG. 7 may be similar elements to those illustrated in FIG. 4 in which similar elements may be indicated by reference numbers ending in, and/or containing, the same digits, letters, and/or the like. FIG. 6 further illustrates a target system 600, decoder 630, and memory device 650. In some embodiments, the target system 600 may communicate with the memory device 650 with an HDM decoder range (e.g., use addresses on the memory media 262 mapped to the HDM memory range). In some embodiments, the decoder 630 may support a load/store interface to the memory media 680. In some embodiments, the controller 670 may map target host memory accesses to the memory media 680. In some embodiments, some regions of the storage media 690 may be copied to the mapping area of the memory media 680. These functions may be used to support load/store operations from the target system 600.

At block 710, according to embodiments, access log information may be received for an application. For example, the memory device 650 may send log information from an access log module 660 (e.g., DPAs) to a log module 622 at the device driver 620 and log module 612 at the cache manager 610. In some embodiments, the memory device 650 may have the capability to log runtime load/store addresses and timestamps. In some embodiments, the specific pattern of load/store addresses within the workload may differ depending on the configuration of both the memory device 650 and the system it is used with. Generally, an access log of a memory device may not be accessed by a target system. For example, DDR access patterns generally cannot be logged by a host. However, via some dual-mode SSDs, e.g., CXL-compatible devices, memory access is possible since CXL allows for asynchronous memory access. However, in some embodiments, asynchronous memory access may not support access logs, because there may not be room to store the logging. Thus, a host may not have access to the DPAs. However, in some embodiments, a memory access protocol (e.g., CXL.io) may allow for logging in memory access mode. Thus, in some embodiments, a host may retrieve DPAs from a CXL or other dual-mode memory device. In some embodiments, in order to access the load/store address log, the device driver may employ CXL.io and retrieve the log from the device.

In some embodiments, a log module 612 may convert the DPAs to Host Virtual Addresses (HVAs) or HPA patterns. In some embodiments, the cache manager 610 may process/filter the log as an input workload set. In some embodiments, the input workload set may be equivalent to the input workload set utilized during the training of the model (weights in weight set module 330). In some embodiments, the cache manager 610 may be responsible for managing multiple inference weight sets, which are determined based on the type of application being executed. Furthermore, since a target system may be connected to multiple memory devices, it may know which memory device a DPA belongs to. Thus, in some embodiments, the HVA and HPA patterns may allow the host to know which storage device a DPA belongs to. Generally, HVAs may have the same value. However, HPA patterns may continually change. Thus, in some embodiments, it may be beneficial to convert physical addresses to virtual addresses. In some embodiments, a weight set module 614 may also generate virtual addresses if the input is virtual addresses. In some embodiments, a log of the log module 612 may be any size, e.g., 100 or 200 pages in size.

In some embodiments, the log module 612 may filter the HPAs for load data. For example, the memory device 650 may send all access log information to the target system 600. In some embodiments, since the target system 600 may use, e.g., load data, the log module 612 may filter out store request data leaving only load data. In some embodiments, the filtering may be the same as done when preparing a training input workload. Thus, the training data and runtime data may be similar, allowing the weight set module 614 to output inferred addresses more accurately.

At block 720, according to embodiments, cache address information may be determined using the access log information and application weights. In some embodiments, the weight set module 614 may receive the data from the log module 612, and output inferred HPAs to an HPA module 616. In some embodiments, the weight set module 614 may use weights received from the weight set module 330, and calculate the HPAs using the received weights. In some embodiments, the target system 600 may update the weight set module 614 as weights are received from the weight set module 330. In some embodiments, based on the accuracy of the data, the weight set module 614 may be run at more frequent intervals.

In some embodiments, a target system may have multiple weight sets. In some embodiments, based on the application, the target system may use the appropriate weight set to populate the memory media. In some embodiments, the application may communicate its type to the runtime cache manager 610 in order to facilitate the selection of the appropriate weight set.

In some embodiments, the cache address information may be returned to the memory device. In some embodiments, the runtime cache manager 610 may generate an HPA pattern based on the likelihood of future access, e.g., based on the weight set module 614. In some embodiments, the HPA patterns from the HPA module 616 may be received by the device driver 620 at an HPA module 624. In some embodiments, the device driver 620 may send the HPA patterns from the HPA module 624 to the device to update the memory media 680 after decision making at the decision module 626 based on an HPA set and cache status, enabling the memory media 680 to be updated accordingly. Thus, based on the HPA patterns from the HPA module 624, in some embodiments, the controller 670 may load inferred HPA patterns from the storage media 690 to the memory media 680. In some embodiments, the cache manager 610 may generate multiple HPA sets by considering the likelihood of future access for improved caching efficiency.

In some embodiments, the HPA patterns may be received by a decision module 626. In some embodiments, if the memory media 680 has enough space (e.g., pages), the cache may be updated via the controller 670. In some embodiments, this process can be run periodically (e.g., every minute, every 30 minutes, every hour, etc.). In some embodiments, if the decision module 626 has a high level of confidence, the memory media 680 may be updated more frequently. For example, if the weight set module 614 has been trained with a lot of training data and has better predictability, the memory media 680 may be loaded more frequently since the data may be accessed sooner.

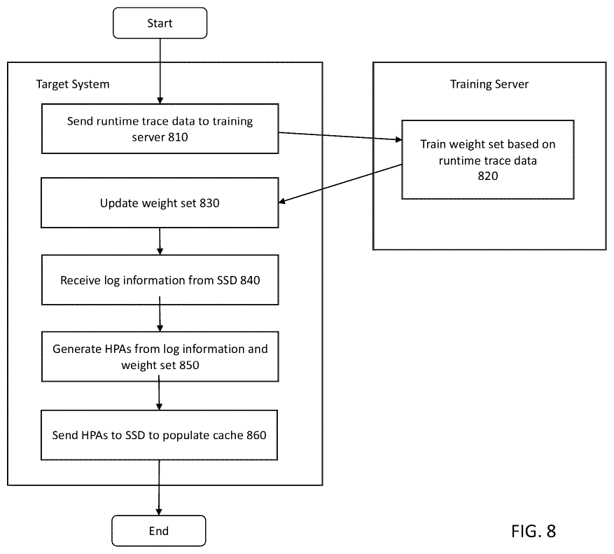

FIG. 8 illustrates a flowchart of an example procedure to populate the cache using a training server in accordance with example embodiments of the disclosure. At block 810, according to embodiments, a target system may send runtime trace data for an application and system configuration to a training server. In some embodiments, the target system may run a workload for an application and generate trace data based on the workload. In some embodiments, multiple workloads may be used to generate the trace data. In some embodiments, the runtime trace data may not be sent to the training server and may be handled by the target system. Furthermore, in some embodiments, the target system may receive weight information from the training server and configure a weight set at the target system. In some embodiments, runtime trace data may not be sent to the training server, and other data may be sent to the training server. For example, historical data or log data may be sent to the training server.

At block 820, according to embodiments, the training server may receive the data and train weights for the application and system configuration using the runtime trace data. In some embodiments, the training server may aggregate data from multiple target systems to generate the weights. In some embodiments, the training server may generate multiple weights for an application and determine which weights to send to the target system based on, e.g., system configuration.

At block 830, according to embodiments, the target system may receive the weights from the training server and update a weight set module on the target system 802. In some embodiments, the target system may receive multiple weights for an application and may determine which weight set to use based on need or resources. For example, if the target system gives a low priority to an application, a weight set with low weights for the application may be used. In some embodiments, the target system may not update a weight set on the target system and may use the weight set on the training server when it retrieves data from the memory device.

At block 840, according to embodiments, the target system may receive log information from a memory device. In some embodiments, the log information may include memory accesses, timestamps, and/or metadata. In some embodiments, the target system may not receive log information and may receive other information to retrieve data from the memory device. In some embodiments, the target system may use AI to determine what information may be retrieved from the memory device.

At block 850, the target system may use the log information and weights to generate inferred HPA patterns for an application. In some embodiments, the target system may generate virtual addresses to be used to populate the memory media. At block 860, the target system may send the inferred HPA patterns to the memory device to populate the memory media on the memory device.

The principles disclosed herein have independent utility and may be embodied individually, and not every embodiment may utilize every principle. However, the principles may also be embodied in various combinations, some of which may amplify the benefits of the individual principles in a synergistic manner.

For purposes of illustrating the inventive principles of the disclosure, some example embodiments may be described in the context of specific implementation details such as a processing system that may implement a NUMA architecture, memory devices, and/or pools that may be connected to a processing system using an interconnect interface and/or protocol Compute Express Link (CXL), and/or the like. However, the principles are not limited to these example details and may be implemented using any other type of system architecture, interfaces, protocols, and/or the like.

In some embodiments, the latency of a memory device may refer to the delay between a memory device and the processor in accessing memory. Furthermore, latency may include delays caused by hardware such as the read-write speeds to access a memory device, and/or the structure of an arrayed memory device producing individual delays in reaching the individual elements of the array. For example, a first memory device in the form of DRAM may have a faster read/write speed than a second memory device in the form of a NAND device. Furthermore, the latency of a memory device may change over time based on conditions such as the relative network load, as well as performance of the memory device over time, and environmental factors such as changing temperature influencing delays on the signal path.

Although some example embodiments may be described in the context of specific implementation details such as a processing system that may implement a NUMA architecture, memory devices, and/or pools that may be connected to a processing system using an interconnect interface and/or protocol CXL, and/or the like, the principles are not limited to these example details and may be implemented using any other type of system architecture, interfaces, protocols, and/or the like. For example, in some embodiments, one or more memory devices may be connected using any type of interface and/or protocol including Peripheral Component Interconnect Express (PCIe), Nonvolatile Memory Express (NVMe), NVMe-over-fabric (NVMe oF), Advanced extensible Interface (AXI), Ultra Path Interconnect (UPI), Ethernet, Transmission Control Protocol/Internet Protocol (TCP/IP), remote direct memory access (RDMA), RDMA over Converged Ethernet (ROCE), FibreChannel, InfiniBand, Serial ATA (SATA), Small Computer Systems Interface (SCSI), Serial Attached SCSI (SAS), iWARP, and/or the like, or any combination thereof. In some embodiments, an interconnect interface may be implemented with one or more memory semantic and/or memory coherent interfaces and/or protocols including one or more CXL protocols such as CXL.mem, CXL.io, and/or CXL.cache, Gen-Z, Coherent Accelerator Processor Interface (CAPI), Cache Coherent Interconnect for Accelerators (CCIX), and/or the like, or any combination thereof. Any of the memory devices may be implemented with one or more of any type of memory device interface including DDR, DDR2, DDR3, DDR4, DDR5, LPDDRX, Open Memory Interface (OMI), NVLink, High Bandwidth Memory (HBM), HBM2, HBM3, and/or the like.

In some embodiments, any of the memory devices, memory pools, hosts, and/or the like, or components thereof, may be implemented in any physical and/or electrical configuration and/or form factor such as a free-standing apparatus, an add-in card such as a PCIe adapter or expansion card, a plug-in device, for example, that may plug into a connector and/or slot of a server chassis (e.g., a connector on a backplane and/or a midplane of a server or other apparatus), and/or the like. In some embodiments, any of the memory devices, memory pools, hosts, and/or the like, or components thereof, may be implemented in a form factor for a storage device such as 3.5 inch, 2.5 inch, 1.8 inch, M.2, Enterprise and Data Center SSD Form Factor (EDSFF), NF1, and/or the like, using any connector configuration for the interconnect interface such as a SATA connector, SCSI connector, SAS connector, M.2 connector, U.2 connector, U.3 connector, and/or the like. Any of the devices disclosed herein may be implemented entirely or partially with, and/or used in connection with, a server chassis, server rack, dataroom, datacenter, edge datacenter, mobile edge datacenter, and/or any combinations thereof. In some embodiments, any of the memory devices, memory pools, hosts, and/or the like, or components thereof, may be implemented as a CXL Type-1 device, a CXL Type-2 device, a CXL Type-3 device, and/or the like.

In some embodiments, any of the functionality described herein, including, for example, any of the logic to implement tiering, device selection, and/or the like, may be implemented with hardware, software, or a combination thereof including combinational logic, sequential logic, one or more timers, counters, registers, and/or state machines, one or more complex programmable logic devices (CPLDs), field programmable gate arrays (FPGAs), application specific integrated circuits (ASICs), central processing units (CPUs) such as complex instruction set computer (CISC) processors such as x86 processors and/or reduced instruction set computer (RISC) processors such as ARM processors, graphics processing units (GPUs), neural processing units (NPUs), tensor processing units (TPUs) and/or the like, executing instructions stored in any type of memory, or any combination thereof. In some embodiments, one or more components may be implemented as a system-on-chip (SOC).

In this disclosure, numerous specific details are set forth in order to provide a thorough understanding of the disclosure, but the disclosed aspects may be practiced without these specific details. In other instances, well-known methods, procedures, components, and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. The terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

When an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” may include any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

The term “module” may refer to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system-on-a-chip (SoC), an assembly, and so forth. Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, e.g., one or more modules of computer-program instructions, encoded on computer-storage medium for execution by, or to control the operation of data-processing apparatus. Alternatively or additionally, the program instructions can be encoded on an artificially generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

While certain exemplary embodiments have been described and shown in the accompanying drawings, it should be understood that such embodiments merely illustrative, and the scope of this disclosure is not limited to the embodiments described or illustrated herein. The invention may be modified in arrangement and detail without departing from the inventive concepts, and such changes and modifications are considered to fall within the scope of the following claims.

1. A method comprising:
receiving, from a memory device, access information for an application; and
determining, using the access information and application weights, address information.

2. The method of claim 1, wherein the application weights correspond to a usage of the application.

3. The method of claim 1, wherein the access information comprises at least one of one or more addresses and timestamp information.

4. The method of claim 1, further comprising sending, to the memory device, the address information.

5. The method of claim 4, further comprising filtering entries of store requests from the access information.

6. The method of claim 1, wherein sending the address information comprises:
determining an available size of a memory media; and
returning the address information based on the available size of the memory media.

7. The method of claim 1, further comprising:
sending trace information to a training system, wherein the trace information corresponds to an operation of an application;
receiving a weight set from the training system, wherein the weight set is based on the trace information; and
modifying the application weights based on the weight set.

8. The method of claim 7, wherein the access information is first access information;
and wherein the trace information comprises second access information.

9. The method of claim 7, wherein the trace information comprises load information for an application.

10. A device comprising:
memory media;
storage media; and
one or more circuits configured to perform one or more operations comprising:
sending access information;
receiving address information based on the access information; and
populating, from the storage media using the address information, the memory media with data.

11. The device of claim 10, wherein the access information comprises access data for an application on the memory media and storage media.

12. The device of claim 10, wherein the address information corresponds to an application on a host device.

13. A system comprising:
a memory device comprising memory media and storage media, wherein the memory device is configured to perform one or more operations comprising:
sending access information;
receiving address information; and
populating, from the storage media, the memory media with data using the address information; and
a device comprising one or more circuits, wherein the one or more circuits is configured to perform one or more operations comprising:
receiving, from the memory device, the access information;
determining, using the access information and application weights, the address information; and
sending, to the memory device, the address information.

14. The system of claim 13, wherein the application weights correspond to a usage of an application.

15. The system of claim 13, wherein the access information comprises at least one of one or more addresses and timestamp information.

16. The system of claim 13, wherein the one or more circuits is further configured to perform one or more operations comprising modifying the access information.

17. The system of claim 14, wherein modifying the access information comprises filtering entries of store requests from the access information.

18. The system of claim 13, wherein sending the address information comprises:
determining an available size of the memory media; and
returning the address information based on the available size of the memory media.

19. The system of claim 13, wherein the one or more circuits is further configured to perform one or more operations comprising:
sending, to a training system, trace information;
receiving a weight set from the training system, wherein the weight set is based on the trace information; and
modifying the application weights based on the weight set.

20. The system of claim 19, wherein the access information is first access information;
and wherein the trace information comprises second access information.
